(19) United States
(12) Patent Application Publication
(10) Pub. No.: US 2015/0221062 A1
(43) Pub. Date: Aug. 6, 2015

(54) METHOD AND APPARATUS FOR PROCESSING GRAPHICS DATA

(71) Applicant: Samsung Electronics Co., Ltd., Suwon-si (KR)

(72) Inventors: Minyoung SON, Hwaseong-si (KR); Haewoo PARK, Seoul (KR); Minkyu JEONG, Yongin-si (KR); Sangoak WOO, Anyang-si (KR)

(73) Assignee: SAMSUNG ELECTRONICS CO., LTD., Suwon-si (KR)

(21) Appl. No.: 14/532,182

(22) Filed: Nov. 4, 2014

(30) Foreign Application Priority Data
Feb. 6, 2014 (KR) 10-2014-0013824

(51) Int. Cl. G06T 1/20; G06T 1/60

(52) U.S. Cl. CPC G06T 1/20; G06T 1/60

(57) ABSTRACT

A method of processing graphics data includes obtaining at least one command for rendering the graphics data, determining, from among graphics data that is drawn in the rendering, graphics data to be used in another rendering based on the at least one obtained command, and transmitting, to a device for rendering the graphics data, a control signal to record the determined graphics data in a buffer. According to the method, the power consumed by a device using the method for rendering graphics data may be reduced.

### RELATED APPLICATIONS

This application claims the benefit under 35 USC 119(a) of Korean Patent Application No. 10-2014-0013824, filed on Feb. 6, 2014, in the Korean Intellectual Property Office, the entire disclosure of which is incorporated herein by reference for all purposes.

### BACKGROUND

1. Field

The following description relates to methods and apparatuses for processing graphics data.

2. Description of Related Art

Devices for displaying three-dimensional graphics data on a screen have become increasingly popular. In mobile devices, as the number of processing cores has gradually increased, many mobile devices can now perform to the level of a personal computer (PC).

In such a device, when graphics data is displayed on a screen, one factor that is considered is power consumption. Even when the performance of the device is good, the user may want to limit the use of the device due to power consumption. Also, the power consumption may lead to heat generated by the device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of processing graphics data, the method including obtaining at least one command for rendering the graphics data, determining, from among graphics data that is drawn in the rendering, graphics data to be used in another rendering based on the at least one obtained command, and transmitting, to a device for rendering the graphics data, a control signal to record the determined graphics data in a buffer..

The determining may include determining whether the at least one obtained command corresponds to a command pattern.

The determining of whether the at least one obtained command corresponds to the command pattern may include detecting the command pattern including a command from among the at least one obtained command, determining whether another command included in the detected command pattern exists among the at least one obtained command, and determining whether a combination of the command and the another command correspond to the command pattern.

The determining may include determining whether a command to delete a buffer, which has been allocated to first graphics data among the drawn graphics, is included in the at least one obtained command, and determining second graphics data except the first graphics data among the drawn graphics data as graphics data that is used after the operation, in response to the command to delete the buffer being included in the at least one obtained command.

The transmitting may include changing a command to record the drawn graphics data based on the recording control signal, and transmitting the changed command to the graphics data rendering device.

The transmitting may include recording the determined graphics data in the buffer that has been allocated to the determined graphics data from a point of time when the control signal is transmitted, in response to the recording control signal being transmitted while the recording of the drawn graphics data is performed.

The determining may include determining, based on the at least one obtained command, graphics data to be used in an operation about a second frame after an operation about a first frame.

The rendering of graphics data for a frame may include rendering the graphics data and performing a next operation.

The determining may include storing the first graphics data in a virtual buffer.

The method may include storing the at least one obtained command in a queue.

The at least one obtained command may include a plurality of commands and the command pattern may include any one or any combination of the plurality of commands.

In one general aspect, there is provided an apparatus for processing graphics data, the apparatus including an input configured to obtain at least one command to render graphics data, a controller configured to determine, from among graphics data that is drawn in the rendering, graphics data to be used in another rendering, based on the at least one obtained command, and an output configured to transmit to a graphics data rendering device a control signal to record the determined graphics data in a buffer.

The controller may be further configured to determine whether the at least one obtained command corresponds to a predetermined command pattern.

The controller may be further configured to detect a command pattern including a command from among the at least one obtained command, determine whether other command included in the detected command pattern exists among the at least one obtained command, and determine whether a combination of the command and the other command correspond to the command pattern.

The controller may be further configured to determine whether a command to delete a buffer, which has been allocated to first graphics data among the drawn graphics, is included in the at least one obtained command, and determine second graphics data except the first graphics data among the drawn graphics data, as graphics data that is used after the operation, in response to the command to delete the buffer being included in the at least one obtained command.

The controller may be further configured to change a command to record the drawn graphics data based on the recording control signal, and to transmit the changed command to the graphics data rendering device.

The output may be further configured to record the determined graphics data in the buffer that has been allocated to the determined graphics data from a point of time when the control signal is transmitted, in response to the recording control signal being transmitted while the recording of the drawn graphics data is performed.

The controller may be further configured to determine, based on the at least one obtained command, graphics data that is used in an operation about a second frame after an operation about a first frame.

The output may be further configured to render graphics data for a frame based on rendering graphics data and performing another operation.

The controller may be further configured to store the first graphics data in a virtual buffer.

Other features and aspects will be apparent from the following detailed description, the drawings, and the claims.

### BRIEF DESCRIPTION OF THE DRAWINGS

FIG. 1 is a diagram illustrating an example of a system for processing graphics data.

FIG. 2 is a diagram illustrating an example of a method of processing graphics data.

FIG. 3 is a diagram illustrating an example of a method of determining whether at least one command obtained by a graphics data processing apparatus is included in a predetermined command pattern.

FIG. 4 is a diagram illustrating an example of a method of determining whether a predetermined operation result is used in another operation based on at least one of commands obtained by a graphics data processing apparatus 100.

FIG. 5 is a diagram illustrating an example of a method of controlling a device for rendering graphics data based on the result of analysis of commands obtained by the graphics data processing apparatus.

FIG. 6 is a diagram illustrating an example of a method of transmitting, by the graphics data processing apparatus 100, a recording control signal to a graphic processing unit (GPU) which is performing the operation of rendering the graphics data.

FIG. 7 is a diagram illustrating an example of a method of operating a virtual buffer used in a graphics data processing apparatus.

FIG. 8 is a diagram illustrating an example of a graphics data processing apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses, and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

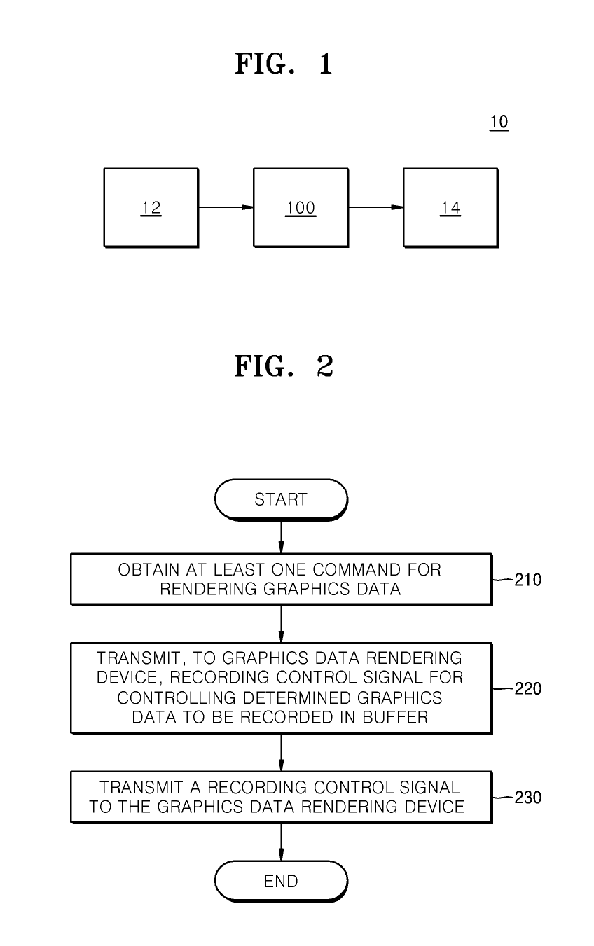

FIG. 1 is a diagram illustrating an example of a system 10 for processing graphics data. While components related to the present example are illustrated in the graphics data processing system 10 of FIG. 1, it is understood that those skilled in the art may include other general components. Referring to FIG. 1, the graphics data processing system 10 may include a central processing unit (CPU) 12, a graphics data processing apparatus 100, and a graphics processing unit (GPU) 14.

The CPU 12 may execute a graphic application. The CPU 12 may access a graphic library to transmit a command for processing graphics data to the GPU 14. The graphic library may transmit the command for processing the graphics data to a graphic driver.

The graphics data processing apparatus 100 may analyze the command transmitted to the graphic driver and optimize the rendering of the graphics data performed in the GPU 14. For example, the graphics data processing apparatus 100 may analyze the command transmitted to the graphic driver and determine whether the result of rendering the graphics data will be used in a next operation. If the result of the rendering is not used in the next operation, the graphics data processing apparatus 100 transmits a control signal to the GPU 14 not to store the result of rendering the graphics data.

Power consumption of the graphics data processing apparatus 100 may be reduced because non-essential information is not stored at the GPU 14. The GPU 14 is provided information on whether to reuse the operation result, based on the analysis result of the command.

FIG. 2 is a diagram illustrating an example of a method of processing graphics data. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. The above description of FIG. 1, is also applicable to FIG. 2, and is incorporated herein by reference. Thus, the above description may not be repeated here.

In 210, the graphics data processing apparatus 100 may obtain at least one command for rendering graphics data. The at least one command may be transmitted to the graphics data processing apparatus 100 based on a command of the graphic application executed in the CPU 12.

The graphics data processing apparatus 100 may store the at least one command in a queue. The number of commands stored in the queue may vary depending on the user's setting.

In 220, the graphics data processing apparatus 100 may determine whether graphics data are to be used in another operation after the operation of rendering graphics data. The graphics data processing apparatus 100 may determine whether the at least one command corresponds to the predetermined command pattern to determine whether the graphics data is to be used in another operation. The predetermined command pattern may be one command or a combination of commands.

When rendering a multi-pass composed of a plurality of passes, the graphics data processing apparatus 100 may determine whether to record the operation result according to the performance result of the current command based on the predetermined command pattern. For example, when rendering the multi-pass composed of three passes, each pass includes an object that is to be rendered. The graphics data processing apparatus 100 may analyze the command pattern between different passes to determine whether to record the result of rendering the object. For example, when the rendering is performed in pass no. 2 based on the result of the rendering performed in passes nos. 0 and 1, the rendering result that is not used in pass no. 2 may be deleted from the buffer of pass nos. 0 and 1. As another example, when rendering is performed in pass no. 2 and only color information is used from among the rendering results of passes nos. 1 and 2, the graphics data processing apparatus 100 may delete information, such as the depth information and stencil information except for color information, from the buffer of passes nos. 0 and 1.

Furthermore, the graphics data processing apparatus 100 may determine whether to record the result of rendering of the first frame based on the command pattern between the first frame and the second frame, which is the frame after the first frame. The graphics data processing apparatus 100 may analyze the command pattern between frames to determine whether to record the operation result. For example, in the multi-pass rendering, when three passes render the first frame and the following three passes render the second frame, the deletion command may be performed before rendering the second frame. The graphics data processing apparatus 100 may analyze the object to be deleted in response to the deletion command based on the predetermined pattern and may not record the object to be deleted. The graphics data processing apparatus 100 may enhance the rendering efficiency by reducing power consumed during object rendering by not recording the result of rendering that is not used according to the command pattern analysis.

The predetermined command pattern may be determined according to the user's setting. The user may set the command pattern according to the kind of a graphic application that is executed in the CPU 12. For example, when a game application is executed, a command pattern, which frequently occurs in the game application, may be separately set.

For example, the graphics data processing apparatus 100 may obtain a command to perform an operation based on graphics data recorded in a predetermined buffer and a command to delete the predetermined buffer. The graphics data processing apparatus 100 may predict the result of an operation performed on the graphics data recorded in a predetermined buffer in the following operation due to the command to delete the predetermined buffer.

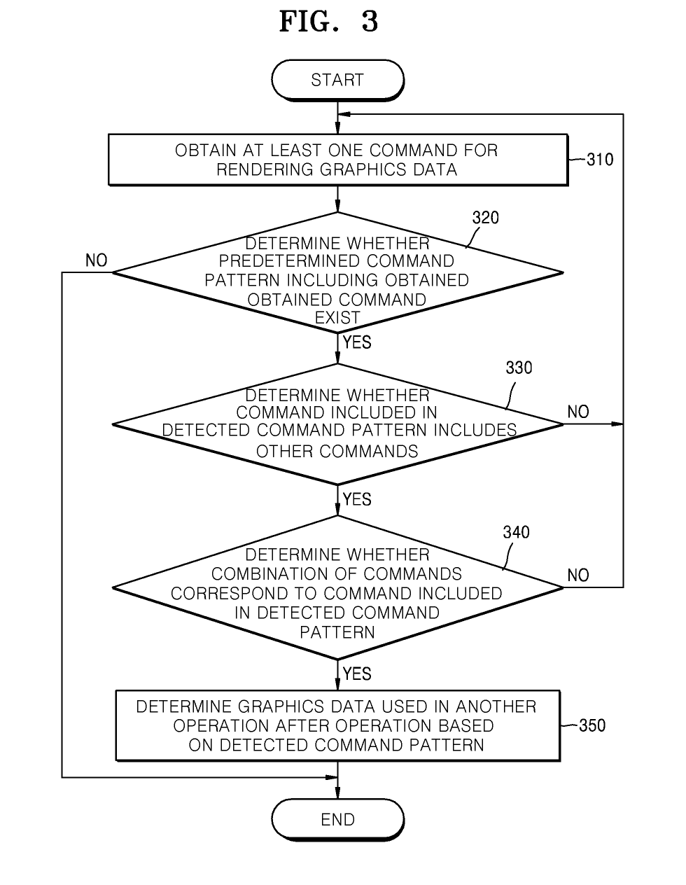

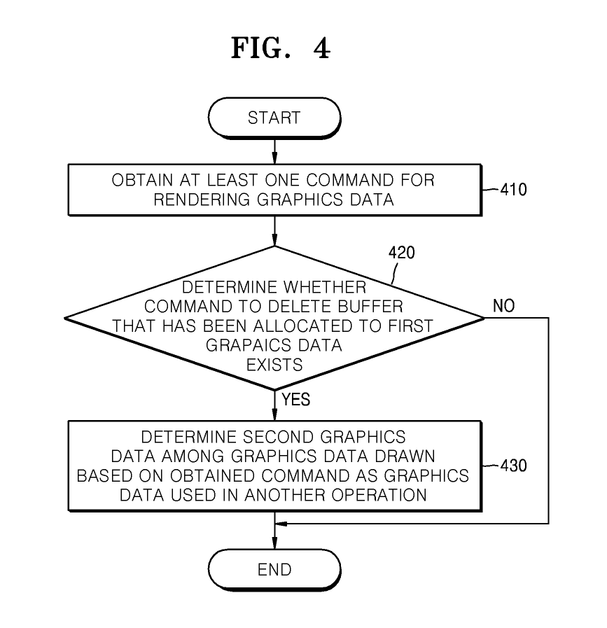

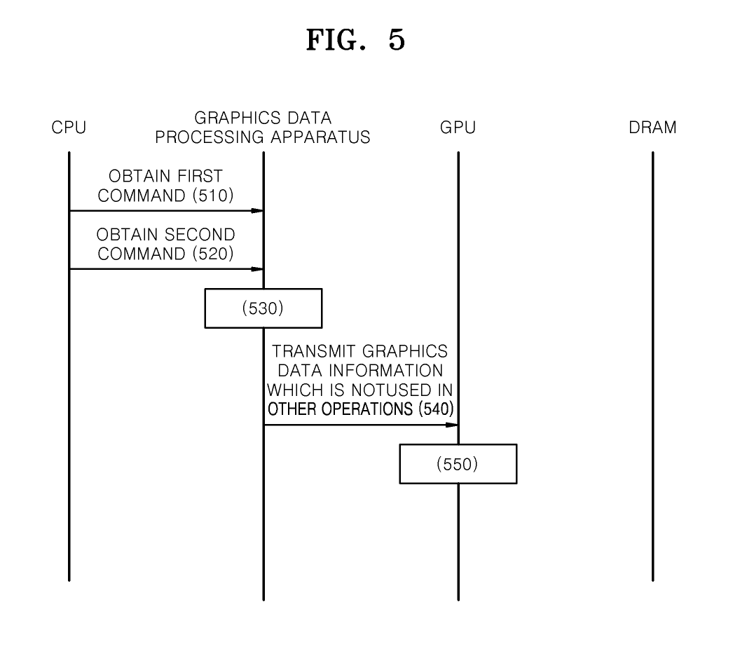

The specific method of determining whether at least one command obtained by the graphics data processing apparatus 100 corresponds to the predetermined command pattern will be described with reference to FIGS. 3 and 4.

In 230, the graphics data processing apparatus 100 may transmit a recording control signal to the graphics data rendering device so that only the determined graphics data may be written back in the buffer. The graphics data rendering device may be a device, such as, for example, a GPU.

The graphics data processing apparatus 100 may transmit to the graphics data rendering device the information that the result of operation performed based on the graphics data recorded in a predetermined buffer will not be used in the following operation. The graphics data rendering device may not write back the result of operation in the buffer when such information is received.

The graphics data processing apparatus 100 may correct the command to be transmitted to the graphics data rendering device. For example, the graphics data processing apparatus 100 may control the graphics data rendering device not to record the operation result by correcting the command associated with the recording of the operation result among one or more commands to be transmitted to the graphics data rendering device.

FIG. 3 is a diagram illustrating an example of a method of determining whether at least one command obtained by a graphics data processing apparatus 100 is included in a predetermined command pattern. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. The above descriptions of FIGS. 1-2, are also applicable to FIG. 3, and are incorporated herein by reference. Thus, the above description may not be repeated here.

In 310, the graphics data processing apparatus 100 may obtain at least one command for rendering the graphics data. The graphics data processing apparatus 100 may store the obtained command in a queue.

In 320, the graphics data processing apparatus 100 may determine whether there is a predetermined command pattern, which includes the obtained command. When a first predetermined command pattern that includes the obtained command exists, the graphics data processing apparatus 100 may detect the predetermined command pattern from among one or more command patterns.

In 330, when a predetermined command pattern including an obtained command exists, the graphics data processing apparatus 100 may determine whether another command is included in the same command pattern among one or more commands. When another command is included in the command pattern, the obtained command may be combined with another command.

If another command is not included in the same command pattern, the graphics data processing apparatus 100 may obtain at least one other command.

In 340, the graphics data processing apparatus 100 may determine whether the combination of the obtained command and the another command corresponds to the combination of the commands in the command pattern.

For example, the graphics data processing apparatus 100 may obtain a command for performing an operation based on graphics data stored in the first buffer and a command for performing an operation based on graphics data stored in the second buffer. The graphics data processing apparatus 100 may obtain another command to delete the first buffer. The graphics data processing apparatus 100 may store the combination of the commands to perform operations on the predetermined buffers and the command to delete the predetermined buffer as a predetermined command pattern. The graphics data processing apparatus 100 may obtain a command to perform an operation based on the graphics data stored in the first buffer, which is an obtained command included in a predetermined command pattern. Furthermore, the graphics data processing apparatus 100 may obtain a command to delete the first buffer, which is another command included in the predetermined command pattern. The graphics data processing apparatus 100 may compare the combination of the command to perform operation based on the graphics data stored in the first buffer and the command to delete the first buffer with the predetermined command pattern.

In 350, when the combination of the obtained command and another command corresponds to the predetermined command pattern, the graphics data processing apparatus 100 may determine graphics data used in other operation after an operation based on the corresponding command pattern.

For example, if the command pattern is composed of a command to perform operation based on graphics data stored in the first buffer and a command to delete the first buffer, the graphics data processing apparatus 100 may confirm that the result of an operation performed based on the graphics data stored in the first buffer is not recorded in the first buffer. The graphics data processing apparatus 100 may confirm that the result of an operation performed based on graphics data stored in the first buffer will not be used in other operation performed thereafter.

The graphics data processing apparatus 100 may transmit to the graphics data rendering device a command to record graphics data except the result of an operation that is not to be used in other operation performed thereafter. According to another example, the graphics data processing apparatus 100 may transmit to the graphics data rendering device a signal to block the recording of information that is not to be used in other operation performed thereafter.

FIG. 4 is a diagram illustrating an example of a method of determining whether a predetermined operation result is used in other operations based on at least one command obtained by a graphics data processing apparatus 100. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. The above descriptions of FIGS. 1-3, are also applicable to FIG. 4, and are incorporated herein by reference. Thus, the above description may not be repeated here.

In 410, the graphics data processing apparatus 100 may obtain at least one command for performing the operation of rendering graphics data. The graphics data processing apparatus 100 may store at least one obtained command in a queue.

In 420, the graphics data processing apparatus 100 may determine whether there is a command, among one or more obtained commands, to delete the buffer that has been allocated to the first graphics data.

In 430, the graphics data processing apparatus 100 may determine, based on at least one obtained command, second graphics data as graphics data that is used in another operation after the present operation.

The graphics data processing apparatus 100 may predict that the buffer to which the first graphics data has been allocated will not be used in another operation.

The graphics data processing apparatus 100 may transmit to the graphics data rendering device a recording control signal to record only the second graphics data, and not the first graphics data, in the buffer.

FIG. 5 is a diagram illustrating an example of a method of controlling a device for rendering graphics data based on the result of analysis of commands obtained by the graphics data processing apparatus 100. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. The above descriptions of FIGS. 1-4, are also applicable to FIG. 5, and are incorporated herein by reference. Thus, the above description may not be repeated here.

In 510, the graphics data processing apparatus 100 may obtain a first command according to the command of the graphics application operated in the CPU 12.

In 520, the graphics data processing apparatus 100 may obtain a second command according to the command of the graphics application operated in the CPU

In 530, the graphics data processing apparatus 100 may determine whether the combination of the first command and the second command corresponds to a predetermined command pattern. The graphics data processing apparatus 100 may detect a predetermined command pattern including the obtained first command. The graphics data processing apparatus 100 may determine whether the second command is included in the detected command pattern. When the second command is included in the detected command pattern, the graphics data processing apparatus 100 may determine whether the combination of the first command and the second command coincides with the detected command pattern.

In 540, the graphics data processing apparatus 100 may transmit, based on the corresponding command pattern, graphics data information that is not used in other operation. For example, if a command pattern is composed of a first command to perform operation based on graphics data stored in the first buffer and a second command to delete the first buffer, the graphics data processing apparatus 100 may confirm that the result of an operation performed based on the graphics data stored in the first buffer is not recorded in the first buffer. The graphics data processing apparatus 100 may confirm that the result of an operation performed based on the graphics data stored in the first buffer will not be used in other operation performed thereafter.

In 550, the graphics data rendering device may not record the graphics data that is not used in future operation in the buffer, based on the graphics data information that is received from the graphics data processing apparatus 100.

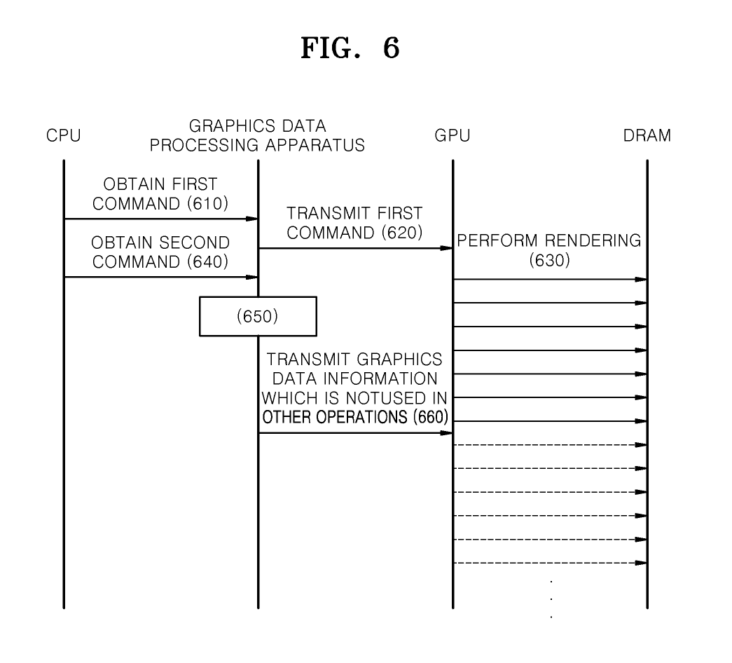

FIG. 6 is a diagram illustrating an example of a method of transmitting, by the graphics data processing apparatus 100, a recording control signal to a graphic processing unit (GPU) that is performing the operation of rendering the graphics data. The operations in FIG. 6 may be performed in the sequence and manner as shown, although the order of some operations may be changed or some of the operations omitted without departing from the spirit and scope of the illustrative examples described. Many of the operations shown in FIG. 6 may be performed in parallel or concurrently. The above descriptions of FIGS. 1-5, are also applicable to FIG. 6, and are incorporated herein by reference. Thus, the above description may not be repeated here.

In 610, the graphics data processing apparatus 100 may obtain a first command according to the command of the graphic application operated in the CPU 12.

In 620, the graphics data processing apparatus 100 may transmit an obtained first command to the GPU.

In 630, the GPU may perform the operation of rendering graphics data based on the first command received from the graphics data processing apparatus 100.

In 640, the graphics data processing apparatus 100 may obtain a second command according to the command of the graphics application executed in the CPU

In 650, the graphics data processing apparatus 100 may determine whether the combination of the first command and the second command corresponds to a predetermine command pattern.

In 660, the graphics data processing apparatus 100 may transmit, based on the corresponding command pattern, graphics data information that is not used in other operation after the operation performed based on the first command, to the GPU.

In 670, when the graphics data information that is not used in other operations, after the operation is performed, is received, the GPU may block the recording of the graphics data information.

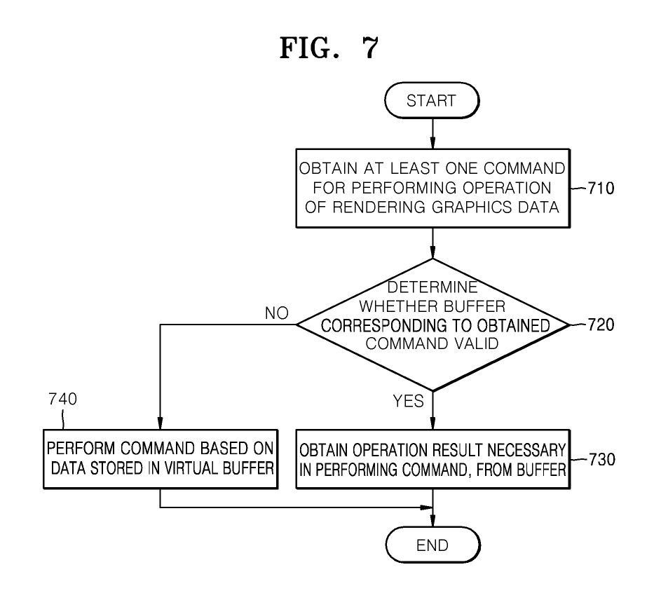

FIG. 7 is a diagram illustrating an example of a method of operating a virtual buffer used in a graphics data processing apparatus 100. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. The above descriptions of FIGS. 1-6, are also applicable to FIG. 7, and are incorporated herein by reference. Thus, the above description may not be repeated here.

In 710, the graphics data processing apparatus 100 may obtain at least one command for performing the operation of rendering the graphics data. The graphics data processing apparatus 100 may store at least one obtained command in a queue. The number of commands stored in the queue may vary depending on the user's setting. The graphics data processing apparatus 100 may determine whether the obtained command corresponds to the predetermined command pattern. Operation 710 of FIG. 7 corresponds to operation 210 of FIG. 2 and the description of operation 210 of FIG. 2 is also applicable to 710, and thus will not be repeated here.

In 720, the graphics data processing apparatus 100 may determine whether the buffer corresponding to the obtained command (hereinafter, referred to as a “2nth command”) is valid. Whether the buffer is valid may be determined based on whether information needed to perform the command obtained in the graphics data processing apparatus 100 has been deleted before obtaining the command.

For example, the operation result needed to perform the 2nth command may be deleted based on the pattern of commands obtained before the 2nth command. Furthermore, when the operation result stored at a specific location in the buffer is deleted, it may be difficult to detect information needed to perform the 2nth command. Hence, the graphics data processing apparatus 100 determines whether the operation result needed to perform the 2nth command has been deleted before obtaining the 2nth command.

In 730, the graphics data processing apparatus 100 may obtain from the buffer the operation result needed to perform the command.

If the result of operation needed to perform the 2nth command is not deleted by the pattern of commands obtained by the graphics data processing apparatus 100 before obtaining the 2nth command, the graphics data processing apparatus 100 may detect the result of operation in the buffer storing the result of operation to perform the 2nth command.

In 740, the graphics data processing apparatus 100 may perform the command based on the data stored in the virtual buffer. For example, when the graphics data processing apparatus 100 does not record the operation result or deletes the recorded operation result according to the deletion command before obtaining the 2nth command, the buffer from which the operation result has been deleted (or in which the operation result was to be recorded), has an invalid value. The graphics data processing apparatus 100 may store deletion information of the buffer from which the operation result has been deleted in the virtual buffer to prevent the occurrence of an error when performing the command by the buffer having an invalid value.

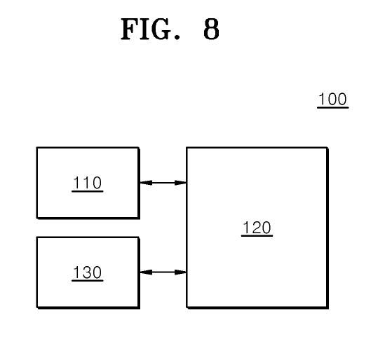

FIG. 8 is a diagram illustrating an example of a graphics data processing apparatus 100. While components related to the present example are illustrated in the graphics data processing apparatus 100 of FIG. 8, it is understood that those skilled in the art may include other general-purpose components. Referring to FIG. 8, the graphics data processing apparatus 100 may include an input unit 110, a controller 120, and an output unit 130.

The input unit 110 may obtain at least one command for performing the operation of rendering the graphics data. The at least one command may be transmitted to the graphics data processing apparatus 100 according to the command of the graphics application operated in the CPU 12.

The input unit may store at least one obtained command in a queue.

The number of commands stored in the queue may vary depending on the user's setting.

The controller 120 may determine, based on the obtained command, the graphics data used in other operation after the operation of rendering graphics data from among the graphics data that is drawn as a result of the operation of rendering graphics data.

The controller 120 may determine whether the obtained at least one command corresponds to a predetermined command pattern. For example, the controller 120 may detect the predetermined command pattern including a command among the obtained at least one command.

The controller 120 may determine whether other command included in the detected command pattern exists among the obtained at least one command. The controller 120 may determine whether the combination of a predetermined command and other command included in the detected command pattern corresponds to the predetermined command pattern. When the combination of a predetermined command and other command included in the detected command pattern corresponds to the predetermined command pattern, the controller 120 may determine from among the graphics data drawn as a result of the operation the graphics used in other operation after the operation. Here, the predetermined command pattern may be composed of one command or may be formed as a combination of a plurality of commands.

According to another example, the controller 120 may determine whether a command to delete the buffer, to which the first graphics data has been allocated, is included in the graphics data drawn based on at least one obtained command. When the deletion command is included in the at least one obtained command, the controller 120 may determine based on the at least one obtained command the second graphics data except the first graphics data among the graphics data drawn as graphics data to be used in other operation after the operation of rendering graphics data.

The output unit 130 may transmit a recording control signal to the graphics data rendering device so that only the graphics data determined by the recording control signal may be recorded in the buffer while the recording of the graphics data drawn as a result of the operation of rendering graphics performed based on at least one command.

According to another example, the recording control signal may be used by the controller 120 to change in the buffer the command for recording the graphics data drawn as a result of the operation of rendering graphics based on at least one obtained command.

According to another example, the output unit 130 may transmit a recording control signal to the graphics data rendering device while recording the graphics data drawn by performing the rendering operation based on at least one command obtained by the graphics data rendering device.

The systems, processes, functions, blocks, processing steps, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a memory, a processing circuits, logic circuits, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of processing graphics data, the method comprising:
obtaining at least one command for rendering the graphics data;
determining, from among graphics data that is drawn in the rendering, graphics data to be used in another rendering based on the at least one obtained command; and
transmitting, to a device for rendering the graphics data, a control signal to record the determined graphics data in a buffer.

2. The method of claim 1, wherein the determining comprises determining whether the at least one obtained command corresponds to a command pattern.

3. The method of claim 2, wherein the determining of whether the at least one obtained command corresponds to the command pattern comprises:
detecting the command pattern including a command from among the at least one obtained command;
determining whether another command included in the detected command pattern exists among the at least one obtained command; and
determining whether a combination of the command and the another command correspond to the command pattern.

4. The method of claim 1, wherein the determining comprises:
determining whether a command to delete a buffer, which has been allocated to first graphics data among the drawn graphics, is included in the at least one obtained command; and
determining second graphics data except the first graphics data among the drawn graphics data as graphics data that is used after the operation, in response to the command to delete the buffer being included in the at least one obtained command.

5. The method of claim 2, wherein the transmitting comprises:
changing a command to record the drawn graphics data based on the recording control signal; and
transmitting the changed command to the graphics data rendering device.

6. The method of claim 2, wherein the transmitting comprises:
recording the determined graphics data in the buffer that has been allocated to the determined graphics data from a point of time when the control signal is transmitted, in response to the recording control signal being transmitted while the recording of the drawn graphics data is performed.

7. The method of claim 1, wherein the determining comprises:
determining, based on the at least one obtained command, graphics data to be used in an operation about a second frame after an operation about a first frame.

8. The method of claim 1, wherein the rendering of graphics data for a frame comprises rendering the graphics data and performing a next operation.

9. The method of claim 4, wherein the determining further comprises storing the first graphics data in a virtual buffer.

10. The method of claim 1, further comprising storing the at least one obtained command in a queue.

11. The method of claim 1, wherein the at least one obtained command comprises a plurality of commands and the command pattern comprises any one or any combination of the plurality of commands.

12. A computer-readable recording medium having recorded thereon a program for performing the method of claim 1 in a computer.

13. An apparatus for processing graphics data, the apparatus comprising:
an input configured to obtain at least one command to render graphics data;
a controller configured to determine, from among graphics data that is drawn in the rendering, graphics data to be used in another rendering, based on the at least one obtained command; and
an output configured to transmit to a graphics data rendering device a control signal to record the determined graphics data in a buffer.

14. The apparatus of claim 11, wherein the controller is further configured to determine whether the at least one obtained command corresponds to a predetermined command pattern.

15. The apparatus of claim 12, wherein the controller is further configured to:
detect a command pattern including a command from among the at least one obtained command;
determine whether other command included in the detected command pattern exists among the at least one obtained command; and
determine whether a combination of the command and the other command correspond to the command pattern.

16. The apparatus of claim 12, wherein the controller is further configured to:
determine whether a command to delete a buffer, which has been allocated to first graphics data among the drawn graphics, is included in the at least one obtained command, and
determine second graphics data except the first graphics data among the drawn graphics data, as graphics data that is used after the operation, in response to the command to delete the buffer being included in the at least one obtained command.

17. The apparatus of claim 12, wherein the controller is further configured to change a command to record the drawn graphics data based on the recording control signal, and to transmit the changed command to the graphics data rendering device.

18. The apparatus of claim 12, wherein the output is further configured to record the determined graphics data in the buffer that has been allocated to the determined graphics data from a point of time when the control signal is transmitted, in response to the recording control signal being transmitted while the recording of the drawn graphics data is performed.

19. The apparatus of claim 11, wherein the controller is further configured to determine, based on the at least one obtained command, graphics data that is used in an operation about a second frame after an operation about a first frame.

20. The apparatus of claim 11, wherein the output is further configured to render graphics data for a frame based on rendering graphics data and performing another operation.

21. The apparatus of claim 14, wherein the controller is further configured to store the first graphics data in a virtual buffer.
